(19) United States
(12) Patent Application Publication
(10) Pub. No.: US 2023/0034463 A1
(43) Pub. Date: Feb. 2, 2023

(54) SELECTIVELY USING SUMMARY BITMAPS FOR DATA SYNCHRONIZATION

(71) Applicant: International Business Machines Corporation, Armonk, NY (US)

(72) Inventors: David Brent Schreiber, Tucson, AZ (US); Matthew Sanchez, Tucson, AZ (US); Matthew J. Ward, Vail, AZ (US); Warren Keith Stanley, Tucson, AZ (US)

(21) Appl. No.: 17/444,159

(22) Filed: Jul. 30, 2021

(51) Int. Cl. G06F 3/06

(52) U.S. Cl. CPC G06F 3/0659; G06F 3/0605; G06F 3/0619; G06F 3/067

(57) ABSTRACT

A computer-implemented method, according to one embodiment, includes: receiving a data modification operation at a primary storage location. A determination is made whether data stored at the primary storage location is currently being synchronized with data stored at a secondary storage location. In response to determining that the data stored at the primary storage location is not currently being synchronized with the data stored at the secondary storage location: one or more instructions to satisfy the data modification operation are sent, and a bit in a first bitmap is set. Additionally, an extent that includes the modified track is determined, and a bit in a first summary bitmap is set. The bit set in the first bitmap corresponds to a track modified as a result of satisfying the data modification operation, while the bit in the first summary bitmap corresponds to the extent that includes the modified track.

### BACKGROUND

The present invention relates to data storage systems, and more specifically, this invention relates to the management and transfer of data between storage locations in a data storage system.

A clustered filesystem is a filesystem which is shared by being simultaneously mounted on multiple servers. Moreover, active file management (AFM) is a scalable, file system caching layer which is implemented in some clustered file systems. AFM allows users to create associations between a local cluster and a remote cluster, as well as define the location and flow of file data therebetween to automate the management of the data. It follows that clustered filesystems are somewhat insulated from experiencing data loss following disaster situations in which one of the multiple servers fail, and are therefore often utilized for data retention purposes.

For example, snapshot-based asynchronous disaster recovery architectures include a primary site and a secondary site. An initial snapshot taken at the primary site is passed to the secondary site, after which incremental snapshots of the primary site are transferred to the secondary site. The primary site often functions as a read-writeable fileset which is able to host applications that are given read/write access to the data stored therein. It follows that the data stored in the primary site is asynchronously replicated to the secondary site. Moreover, a recovery point objective (RPO) setting allows for the frequency at which the incremental snapshots are taken to be specified.

### SUMMARY

A computer-implemented method, according to one embodiment, includes: receiving a data modification operation at a primary storage location. A determination is made as to whether data stored at the primary storage location is currently being synchronized with data stored at a secondary storage location. In response to determining that the data stored at the primary storage location is not currently being synchronized with the data stored at the secondary storage location: one or more instructions to satisfy the data modification operation are sent, and a bit in a first bitmap is set. Additionally, an extent that includes the modified track is determined, and a bit in a first summary bitmap is set. The bit set in the first bitmap corresponds to a track modified as a result of satisfying the data modification operation, while the bit in the first summary bitmap corresponds to the extent that includes the modified track.

A computer program product, according to another embodiment, includes one or more computer readable storage media having program instructions embodied therewith. Moreover, the program instructions are readable and/or executable by a processor to cause the processor to: perform the foregoing method.

A system, according to yet another embodiment, includes: a processor, and logic integrated with the processor, executable by the processor, or integrated with and executable by the processor. Moreover, the logic is configured to: perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a network architecture, in accordance with one embodiment of the present invention.

FIG. 2 is a diagram of a representative hardware environment that may be associated with the servers and/or clients of FIG. 1, in accordance with one embodiment of the present invention.

FIG. 3 is a diagram of a tiered data storage system, in accordance with one embodiment of the present invention.

FIG. 4 is a partial representative view of a distributed data storage system in accordance with one embodiment.

FIG. 5A is a flowchart of a method in accordance with one embodiment.

FIG. 5B is a flowchart of sub-processes for one of the operations in the method of FIG. 5A, in accordance with one embodiment.

FIG. 5C is a flowchart of a method in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products which are able to significantly improve the efficiency at which storage environments implementing data replication are able to operate. Some of the embodiments included herein are able to achieve this improved performance by implementing summary bitmaps which significantly reduces the amount of computing resources that are consumed in order to identify which data has been modified at one storage location but not yet synchronized with another storage location. As a result, various ones of the approaches included herein are able to reduce system processing overhead and decreasing network latency while maintaining high data retention, e.g., as will be described in further detail below.

In one general embodiment, a computer-implemented method includes: receiving a data modification operation at a primary storage location. A determination is made as to whether data stored at the primary storage location is currently being synchronized with data stored at a secondary storage location. In response to determining that the data stored at the primary storage location is not currently being synchronized with the data stored at the secondary storage location: one or more instructions to satisfy the data modification operation are sent, and a bit in a first bitmap is set. Additionally, an extent that includes the modified track is determined, and a bit in a first summary bitmap is set. The bit set in the first bitmap corresponds to a track modified as a result of satisfying the data modification operation, while the bit in the first summary bitmap corresponds to the extent that includes the modified track.

In another general embodiment, a computer program product includes one or more computer readable storage media having program instructions embodied therewith. Moreover, the program instructions are readable and/or executable by a processor to cause the processor to: perform the foregoing method.

In yet another general embodiment, a system includes: a processor, and logic integrated with the processor, executable by the processor, or integrated with and executable by the processor. Moreover, the logic is configured to: perform the foregoing method.

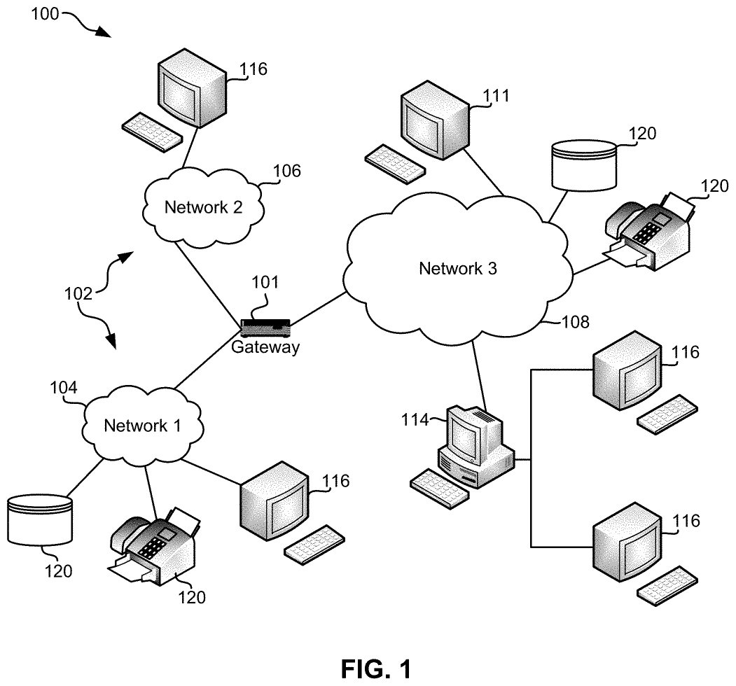

FIG. 1 illustrates an architecture 100, in accordance with one embodiment. As shown in FIG. 1, a plurality of remote networks 102 are provided including a first remote network 104 and a second remote network 106. A gateway 101 may be coupled between the remote networks 102 and a proximate network 108. In the context of the present architecture 100, the networks 104, 106 may each take any form including, but not limited to a local area network (LAN), a wide area network (WAN) such as the Internet, public switched telephone network (PSTN), internal telephone network, etc.

In use, the gateway 101 serves as an entrance point from the remote networks 102 to the proximate network 108. As such, the gateway 101 may function as a router, which is capable of directing a given packet of data that arrives at the gateway 101, and a switch, which furnishes the actual path in and out of the gateway 101 for a given packet.

Further included is at least one data server 114 coupled to the proximate network 108, and which is accessible from the remote networks 102 via the gateway 101. It should be noted that the data server(s) 114 may include any type of computing device/groupware. Coupled to each data server 114 is a plurality of user devices 116. User devices 116 may also be connected directly through one of the networks 104, 106, 108. Such user devices 116 may include a desktop computer, lap-top computer, hand-held computer, printer or any other type of logic. It should be noted that a user device 111 may also be directly coupled to any of the networks, in one embodiment.

A peripheral 120 or series of peripherals 120, e.g., facsimile machines, printers, networked and/or local storage units or systems, etc., may be coupled to one or more of the networks 104, 106, 108. It should be noted that databases and/or additional components may be utilized with, or integrated into, any type of network element coupled to the networks 104, 106, 108. In the context of the present description, a network element may refer to any component of a network.

According to some approaches, methods and systems described herein may be implemented with and/or on virtual systems and/or systems which emulate one or more other systems, such as a UNIX® system which emulates an IBM® z/OS® environment (IBM and all IBM-based trademarks and logos are trademarks or registered trademarks of International Business Machines Corporation and/or its affiliates), a UNIX® system which virtually hosts a known operating system environment, an operating system which emulates an IBM® z/OS® environment, etc. This virtualization and/or emulation may be enhanced through the use of VMware® software, in some embodiments.

In more approaches, one or more networks 104, 106, 108, may represent a cluster of systems commonly referred to as a “cloud.” In cloud computing, shared resources, such as processing power, peripherals, software, data, servers, etc., are provided to any system in the cloud in an on-demand relationship, thereby allowing access and distribution of services across many computing systems. Cloud computing typically involves an Internet connection between the systems operating in the cloud, but other techniques of connecting the systems may also be used.

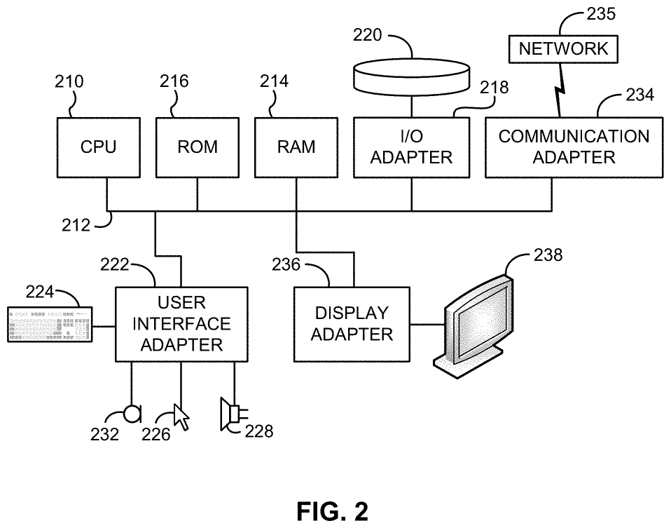

FIG. 2 shows a representative hardware environment associated with a user device 116 and/or server 114 of FIG. 1, in accordance with one embodiment. Such figure illustrates a typical hardware configuration of a workstation having a central processing unit 210, such as a microprocessor, and a number of other units interconnected via a system bus 212.

The workstation shown in FIG. 2 includes a Random Access Memory (RAM) 214, Read Only Memory (ROM) 216, an input/output (I/O) adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen and a digital camera (not shown) to the bus 212, communication adapter 234 for connecting the workstation to a communication network 235 (e.g., a data processing network) and a display adapter 236 for connecting the bus 212 to a display device 238.

The workstation may have resident thereon an operating system such as the Microsoft Windows® Operating System (OS), a macOS®, a UNIX® OS, etc. It will be appreciated that a preferred embodiment may also be implemented on platforms and operating systems other than those mentioned. A preferred embodiment may be written using eXtensible Markup Language (XML), C, and/or C++ language, or other programming languages, along with an object oriented programming methodology. Object oriented programming (OOP), which has become increasingly used to develop complex applications, may be used.

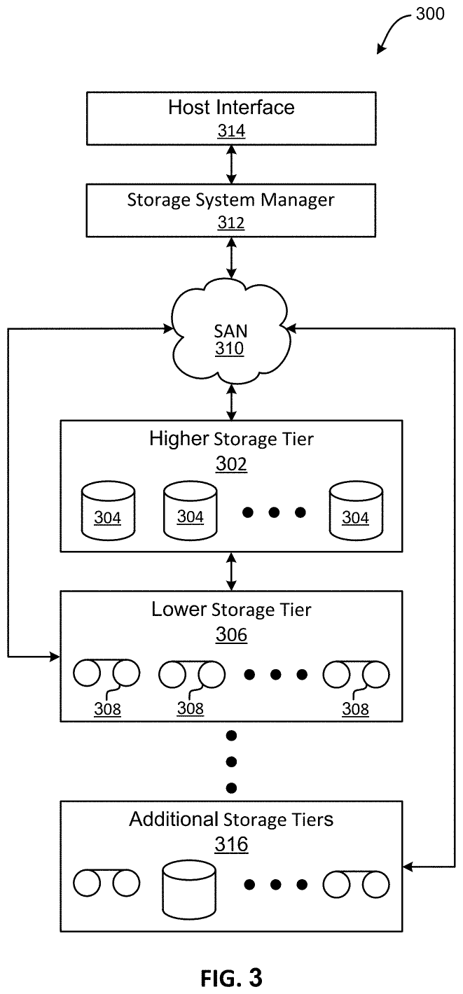

Now referring to FIG. 3, a storage system 300 is shown according to one embodiment. Note that some of the elements shown in FIG. 3 may be implemented as hardware and/or software, according to various embodiments. The storage system 300 may include a storage system manager 312 for communicating with a plurality of media and/or drives on at least one higher storage tier 302 and at least one lower storage tier 306. The higher storage tier(s) 302 preferably may include one or more random access and/or direct access media 304, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 306 may preferably include one or more lower performing storage media 308, including sequential access media such as magnetic tape in tape drives and/or optical media, slower accessing HDDs, slower accessing SSDs, etc., and/or others noted herein or known in the art. One or more additional storage tiers 316 may include any combination of storage memory media as desired by a designer of the system 300. Also, any of the higher storage tiers 302 and/or the lower storage tiers 306 may include some combination of storage devices and/or storage media.

The storage system manager 312 may communicate with the drives and/or storage media 304, 308 on the higher storage tier(s) 302 and lower storage tier(s) 306 through a network 310, such as a storage area network (SAN), as shown in FIG. 3, or some other suitable network type. The storage system manager 312 may also communicate with one or more host systems (not shown) through a host interface 314, which may or may not be a part of the storage system manager 312. The storage system manager 312 and/or any other component of the storage system 300 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 300 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 302, may include a majority of SSD storage media for storing data in a higher performing storage environment, and remaining storage tiers, including lower storage tier 306 and additional storage tiers 316 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 302, while data not having one of these attributes may be stored to the additional storage tiers 316, including lower storage tier 306. Of course, one of skill in the art, upon reading the present descriptions, may devise many other combinations of storage media types to implement into different storage schemes, according to the embodiments presented herein.

According to some embodiments, the storage system (such as 300) may include logic configured to receive a request to open a data set, logic configured to determine if the requested data set is stored to a lower storage tier 306 of a tiered data storage system 300 in multiple associated portions, logic configured to move each associated portion of the requested data set to a higher storage tier 302 of the tiered data storage system 300, and logic configured to assemble the requested data set on the higher storage tier 302 of the tiered data storage system 300 from the associated portions.

Of course, this logic may be implemented as a method on any device and/or system or as a computer program product, according to various embodiments.

As previously mentioned, clustered filesystems allow users to create associations between a local cluster and a remote cluster, as well as define the location and flow of file data therebetween to automate the management of the data. It follows that clustered filesystems are somewhat insulated from experiencing data loss following disaster situations in which one of the multiple servers fail, and are therefore often utilized for data retention purposes. For example, the primary site often functions as a read-writeable fileset which is able to host applications that are given read/write access to the data stored therein, and the data stored in the primary site is replicated to the secondary site over time.

However, successfully performing a full backup of a large data set typically takes a substantial amount of time and computing overhead to complete. This is because conventional systems inspect the data at the primary site to determine which portions have been updated (e.g., modified). It follows that as different data at the primary site continues to be updated over time, these conventional systems are constantly reinspecting the data and consume a substantial amount of computing overhead as well as system throughput to do so.

Additionally, in multi-tasking or multi-user systems, data operations may continue to be received and/or performed on data while it is actively being backed up. This prevents backup operations from being atomic and introduces a version skew that may result in data corruption. For example, if a user moves a file into a directory that has already been backed up, then that file would not be present on the backup media, as the backup operation had already taken place before the addition of the file. Version skew may also cause corruption with files which undesirably change their size or contents underfoot while being read.

An alternative option to safely back up live data is to temporarily disable write access to data during the backup procedure, either by stopping any accessing applications, or by using a locking application programming interface (API) provided by the operating system to enforce exclusive read access. While this option is tolerable for low-availability systems, e.g., such as desktop computers and small workgroup servers on which regular downtime is acceptable, high availability systems cannot tolerate service stoppages.

In sharp contrast to the various shortcomings that have been experienced by conventional systems, various ones of the embodiments included herein are able to reliably and efficiently maintain duplicate copies of data at two different storage locations. By utilizing various bitmaps, at least some of the approaches herein are able to significantly reduce the amount of computing overhead that is involved with actually synchronizing data across the storage locations. These improvements are further realized even in situations where data modifications are received during the synchronization process, e.g., as will be described in further detail below.

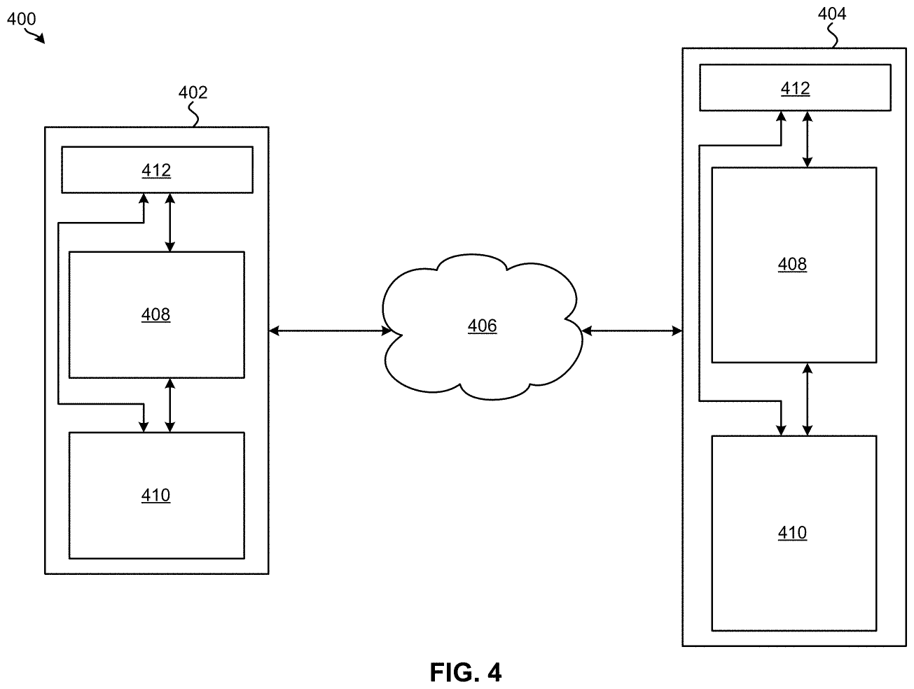

Looking now to FIG. 4, a distributed data storage system 400 is illustrated in accordance with one embodiment. As an option, the present data storage system 400 may be implemented in conjunction with features from any other embodiment listed herein, such as those described with reference to the other FIGS. However, such data storage system 400 and others presented herein may be used in various applications and/or in permutations which may or may not be specifically described in the illustrative embodiments listed herein. Further, the data storage system 400 presented herein may be used in any desired environment. Thus FIG. 4 (and the other FIGS.) may be deemed to include any possible permutation.

As shown, the data storage system 400 includes a source location 402 (e.g., a primary storage location) and a target location 404 (e.g., a secondary storage location) which are connected by a network 406. In some approaches, the source location 402 and the target location 404 each include data storage components (e.g., types of memory) which are capable of achieving different data performance levels. In other words, the source and target storage locations 402, 404 may each include a multi-tier data storage system which includes a lower performance storage tier 410 and a higher performance storage tier 408. With respect to the present description, the lower performance storage tier 410 has a lower level of performance (e.g., a lower achievable throughput, slower data access rates, higher write delays, etc.) at least with respect to that of the higher performance storage tier 408. According to an example, which is in no way intended to limit the invention, the higher performance storage tier 408 includes SSDs while the lower performance storage tier 410 includes HDDs.

Moreover, a controller (e.g., processor) 412 is included in each of the source and target storage locations 402, 404, each of the controllers 412 being electrically coupled to the respective higher and lower performance storage tiers 408, 410. The controllers 412 at the source and target storage locations 402, 404 may also be able to communicate with each other (e.g., send data, commands, requests, etc. to each other) using a connection to network 406.

The network 406 connecting the source and target storage locations 402, 404 may be a WAN according to some approaches. However, the network 406 may include any desired type of network, e.g., such as a LAN, a SAN, a personal area network (PAN), etc., e.g., depending on the approach. For instance, the type of network 406 used to connect the source and target storage locations 402, 404 may depend on the distance separating the storage locations. According to some approaches, the source and target storage locations 402, 404 may be geographically separated by any amount of physical distance.

As described above, data duplication or “disaster recovery” storage architectures implement a source location (also referred to herein as a “primary storage location”) and a target location (also referred to herein as a “secondary storage location”), the two sites being able to transfer data therebetween. For instance, data modifications that are performed at the source location may then be passed to (e.g., replicated at) the removed target location for redundant storage. While some systems implement snapshots to replicate the data across the storage locations, other situations may simply send instructions that prompt the secondary location to replicate the modifications that have been made to the primary location, e.g., as would be appreciated by one skilled in the art after reading the present description.

Accordingly, the source location 402 functions as a “primary storage location”, while the target location 404 serves as a “secondary storage location” in preferred approaches. However, this is in no way intended to be limiting. For example, in other approaches the source location 402 may function as the “secondary storage location”, while the target location 404 serves as the “primary storage location” under normal operation and/or following a disaster recovery situation.

Furthermore, although FIG. 4 only depicts a single source location connected to a single target location, the distributed data storage system 400 may include additional storage locations coupled to the locations depicted in the present embodiment. Thus, the target location 404 includes storage tiers 408, 410 (e.g., memory) having a larger combined storage capacity than that of the storage tiers 408, 410 included in the source location 402. As operations are performed at the source location 402, they are incrementally re-performed at the target location 404 over time using network 406 and various ones of the processes included herein. Accordingly, the controllers 412 may implement various processes of snapshot-based data retention procedures, e.g., as described below with respect to method 500.

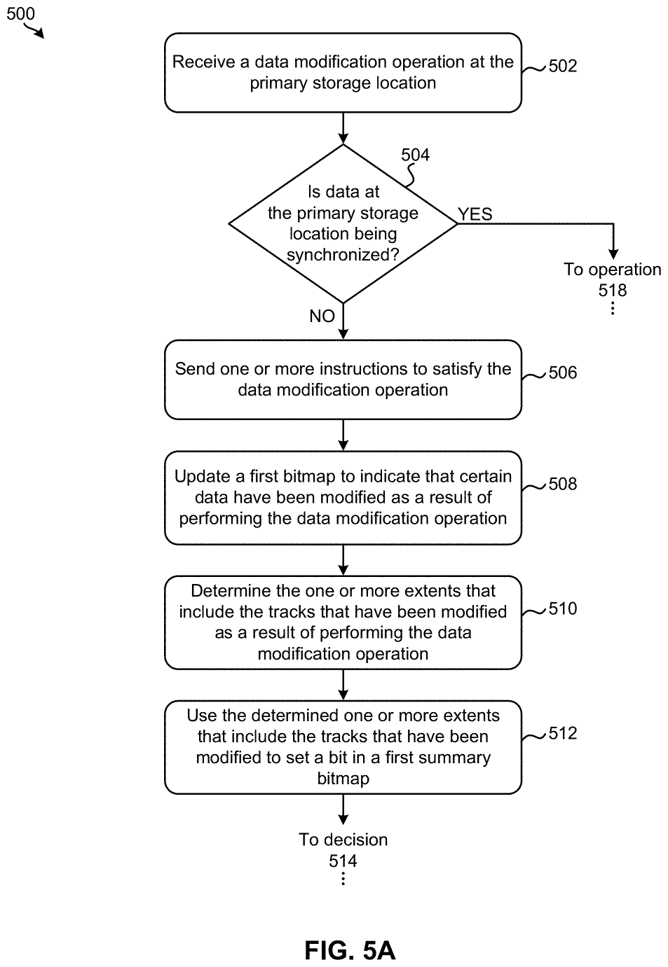

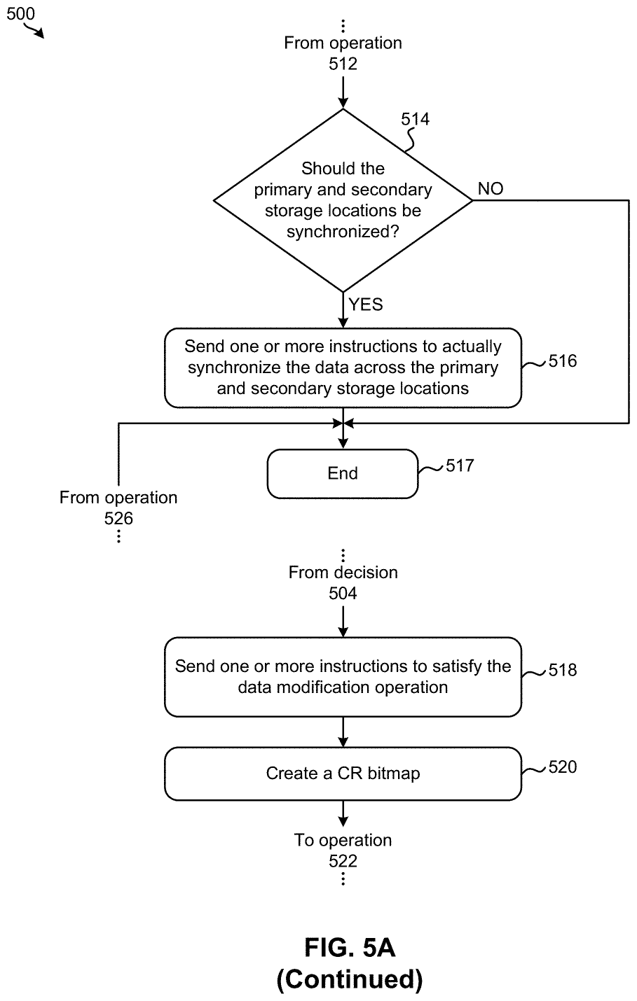

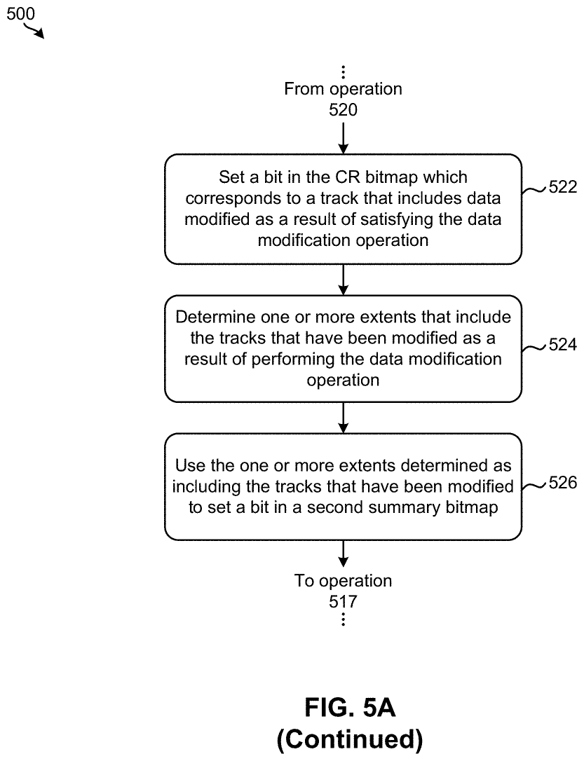

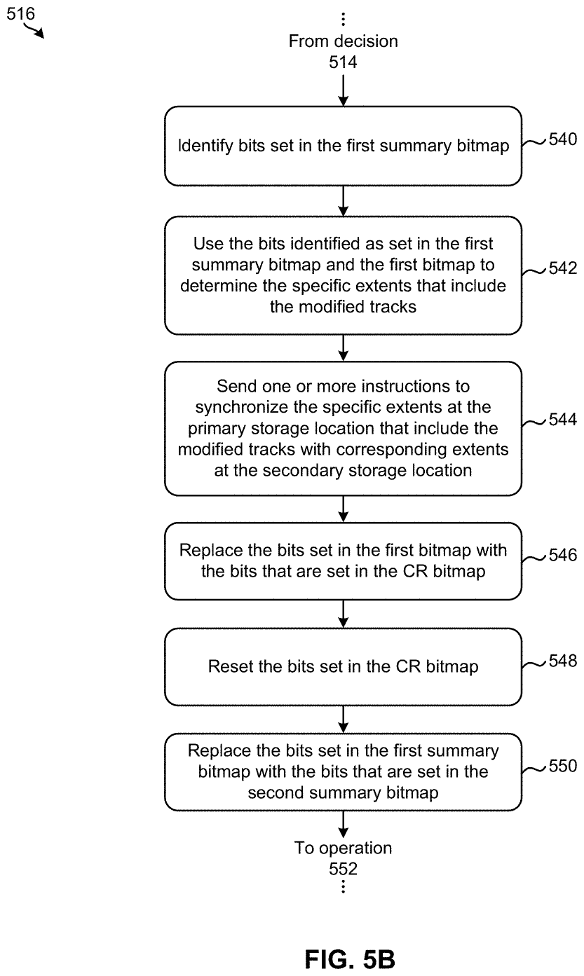

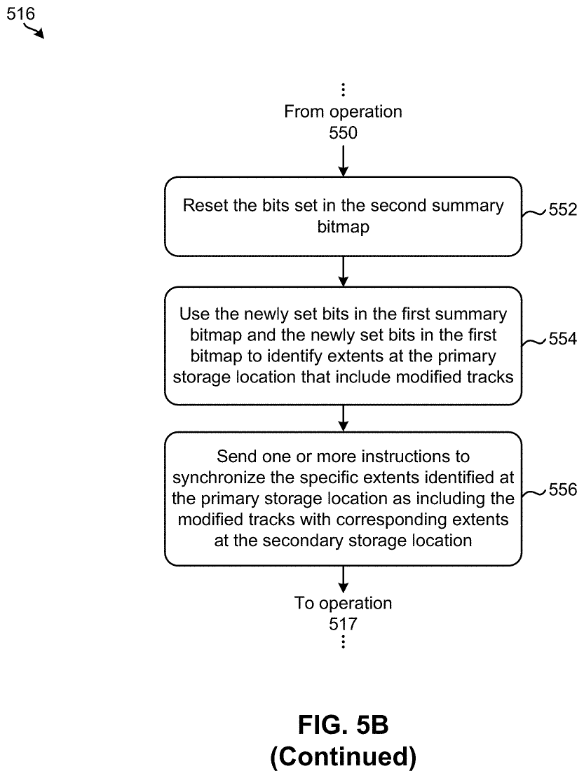

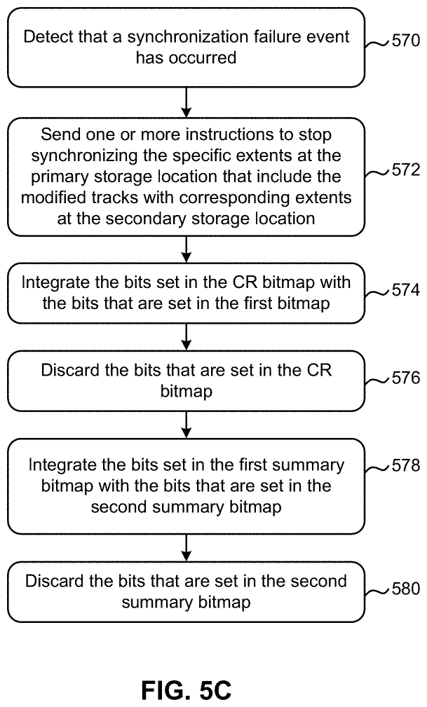

Referring now to FIG. 5A, a flowchart of a method 500 for implementing summary bitmaps for synchronization operations is shown according to one embodiment. The method 500 may be performed in accordance with the present invention in any of the environments depicted in FIGS. 1-4, among others, in various embodiments. Of course, more or less operations than those specifically described in FIG. 5A may be included in method 500, as would be understood by one of skill in the art upon reading the present descriptions.

Each of the steps of the method 500 may be performed by any suitable component of the operating environment. For example, method 500 may be at least partially performed by a controller that is coupled to a primary storage location (e.g., see 410 in FIG. 4). However, in various other embodiments, the method 500 may be partially or entirely performed by a central storage controller, a controller that is coupled to a secondary storage location, a processor, a computer, etc., or some other device having one or more processors therein. Thus, in some embodiments, method 500 may be a computer-implemented method. Moreover, the terms computer, processor and controller may be used interchangeably with regards to any of the embodiments herein, such components being considered equivalents in the many various permutations of the present invention.

Moreover, for those embodiments having a processor, the processor, e.g., processing circuit(s), chip(s), and/or module(s) implemented in hardware and/or software, and preferably having at least one hardware component may be utilized in any device to perform one or more steps of the method 500. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 5A, operation 502 of method 500 includes receiving a data modification operation at the primary storage location. The type of data modification operation that is received varies depending on the situation and may include a data write operation, a deletion operation, a re-write operation, etc. Moreover, the data modification operation may be received from a user, an administrator, a running application, another storage system, a controller, etc.

In response to receiving the data modification operation, method 500 determines whether data stored at the primary storage location is currently being synchronized with data stored at a secondary storage location. See decision 504. In other words, a determination is made as to whether the storage system is actively synchronizing the data at the primary and secondary storage systems. In some approaches decision 504 is performed by determining whether a synchronization procedure (e.g., such as active file management) is currently being performed. As mentioned above, data operations may continue to be received and/or performed on data at the primary storage location while it is actively being backed up (e.g., synchronized) with the data at the secondary location. While these data operations are ultimately performed at the primary storage location, it is preferred that the operations are delayed until the active synchronization has completed to avoid any version skew that may otherwise result in data corruption.

Determining whether the storage system is actively synchronizing the primary and secondary storage locations may be performed differently depending on the approach. For instance, in some approaches decision 504 may be performed by actually inspecting active operations being performed by one or more controllers, while in other approaches decision 504 may be performed by determining whether a synchronization bit has been set, querying the secondary storage location, reviewing an operation log for one or more controllers, etc., or any other processes which would be apparent to one skilled in the art after reading the present description.

In situations where the data stored at the primary storage location is not currently being synchronized with data stored at a secondary storage location, the newly received data modification operations can essentially be performed without introducing risk of data corruption. Thus, in response to determining that the data stored at the primary storage location is not currently being synchronized with data stored at a secondary storage location, method 500 proceeds from decision 504 to operation 506. There, operation 506 includes sending one or more instructions to satisfy the data modification operation. In other words, operation 506 includes actually performing the data modification operation that was received.

Depending on the type of data modification operation, actually performing the data modification operation may vary. For instance, in some situations the data modification operation may be a new data write operation whereby a central processor may send one or more instructions to a memory controller that actually performs the data writes in physical memory. In other situations, the data modification operation may be a deletion whereby a central processor updates a logical-to-physical table (LPT) to indicate certain portions of memory as having been deleted or at least scheduled to be deleted. For instance, the data being deleted may be stored in random access memory and the corresponding blocks of memory may be marked as invalid (e.g., ready for garbage collection).

From operation 506, method 500 proceeds to operation 508 which includes updating a first bitmap to indicate that certain data have been modified as a result of performing the data modification operation. The first bitmap may be updated by setting bits which correspond to the data that has been modified as a result of satisfying the data modification operation. In some approaches, each bit in the first bitmap may correspond to a given portion of the memory at the primary storage location itself. For example, each bit may correspond to a different track at the primary storage location, while multiple tracks may be combined together to form an extent. It should be noted that while certain terms like “track” and “extent” are used herein, these are in no way intended to limit the invention. The data and/or memory storing the data may be divided into any desired number of portions of any desired size and may be referred to as desired.

Updating the first bitmap to indicate that certain data have been modified as a result of performing the data modification operation allows for the system to keep track of modifications that have been made to the data at the primary storage location. These modifications may thereby be maintained and eventually replicated at the secondary storage location to ensure the two copies of the data remain synchronized. However, the first bitmap has a high level of granularity and therefore the process of synchronizing the primary and secondary storage locations only using the bits that are set in the first bitmap would introduce a substantial amount of processing overhead to the system as a whole.

In order to reduce this processing overhead and lower the amount of computing resources consumed, a summary bitmap is preferably utilized. Each bit in the summary bitmap effectively corresponds to a larger portion of memory at the primary storage location than the bits in the first bitmap. The summary bitmap thereby reduces the computational resources that are consumed in order to identify a portion of data that has been modified, e.g., as will be described in further detail below.

Accordingly, operation 510 includes determining the one or more extents that include the tracks that have been modified as a result of performing the data modification operation. In other words, operation 510 calculates the one or more extents which correspond to the modified tracks. This calculation may be performed differently depending on the type of memory, user preferences, system settings, industry standards, etc. For instance, in some approaches operation 510 may be performed by accessing a LPT and extrapolating which extent(s) the modified tracks are included in. Additional information such as metadata may also be used to perform operation 510. According to an example, metadata may identify predetermined sizes of the tracks as well as the extents which may be used to actually calculate which extent a given track is in.

From operation 510, method 500 includes using the information determined in operation 510 to set a bit in a first summary bitmap. See operation 512. As noted above, each bit may correspond to a different track at the primary storage location, while multiple tracks may be combined together to form an extent. Thus, by identifying the one or more extents which include modified tracks therein, the first summary bitmap may be used to keep track of these extents. In some approaches, each bit in the first summary bitmap may correspond to a different one of the extents that include the various tracks of data. The first summary bitmap may thereby have a much lower level of granularity than the first bitmap. The first summary bitmap may be used to quickly and efficiently identify larger regions that include modified data, before using this information to perform a selective lookup in the first bitmap to identify the specific tracks that include the modified data. This significantly reduces the amount of computing resources that are consumed in order to identify which data has been modified at the primary storage location but not yet synchronized with the secondary storage location.

These improvements achieved as a result of implementing summary bitmaps as described herein are particularly desirable in comparison to the conventional shortcomings experienced as a result of having to examine each portion of data individually in order to determine whether any modifications have been made thereto. Moreover, these inefficiencies have been compounded by the frequency by which the conventional systems repeat this examination process. For example, conventional systems implementing asynchronous mirroring without consistency initiate a new examination of the data for any modifications whenever a write is received.

From operation 512, method 500 proceeds to decision 514 which includes determining whether the primary and secondary storage locations should be synchronized. In other words, decision 514 includes determining whether the data stored at the primary storage location should be synchronized with the data stored at the secondary storage location. Depending on the approach, the storage locations may be synchronized periodically according to a predetermined time schedule, in response to a predetermined condition being met (e.g., a certain number of data modification operations being performed), upon user request, etc. It follows that decision 514 may be performed differently depending on the particular approach. For example, in situations where the storage locations are synchronized after a predetermined amount of time has passed since a last synchronization procedure was performed, decision 514 may include determining how long it has been since the primary and secondary storage locations have been synchronized.

In response to determining that the data stored at the primary storage location should be synchronized with the data stored at the secondary storage location, method 500 proceeds to operation 516. There, operation 516 includes sending one or more instructions to actually synchronize the data across the primary and secondary storage locations. The one or more instructions may be sent to a storage controller, a network connection module, the secondary storage location itself, etc., e.g., depending on the particular approach. The process of actually synchronizing the primary and secondary storage locations may also vary depending on the approach, e.g., as will be described in further detail below in FIG. 5B.

With continued reference to FIG. 5A, the flowchart advances from operation 516 to operation 517, whereby method 500 may end. However, it should be noted that although method 500 may end upon reaching operation 517, any one or more of the processes included in method 500 may be repeated in order to process additional data modification operations. In other words, any one or more of the processes included in method 500 may be repeated for subsequently received data modification operations.

Moreover, looking again to decision 514, method 500 jumps directly to operation 517 in response to determining that the primary and secondary storage locations should not be synchronized. As noted above, the storage locations may be synchronized periodically according to a predetermined time schedule, in response to a predetermined condition being met (e.g., a certain number of data modification operations being performed), upon user request, etc. It follows that it may be undesirable to synchronize the storage locations in certain situations.

Referring back now to decision 504, the flowchart proceeds to operation 518 in response to determining that the data stored at the primary storage location is currently being synchronized with data stored at a secondary storage location. There, operation 518 includes sending one or more instructions to satisfy the data modification operation. Accordingly, any one or more of the approaches described above with respect to operation 506 may be utilized in order to perform operation 518. Although the data modification operation has been satisfied, the primary and secondary storage locations are currently being synchronized. It follows that the data which is modified as a result of satisfying the data modification operation in operation 518 will not be implemented at the secondary storage location.

Accordingly, operation 520 includes creating a change recording (CR) bitmap. The CR bitmap effectively tracks data modifications that are performed during active synchronizations, e.g., such that they may be implemented during a subsequent synchronization procedure. It follows that the CR bitmap may only be utilized in situations that involve active synchronization between the storage locations. The granularity of the CR bitmap may be substantially similar to that of the first bitmap, but in some approaches the granularity may be different. In other words, in some approaches each of the bits in the CR bitmap may correspond to a larger or smaller amount of actual data in storage than each of the bits in the first bitmap, but they may be about the same. It should also be noted that the CR bitmap may only actually be created on a first pass of method 500, while being maintained and utilized on subsequent iterations of method 500.

Proceeding to operation 522, a bit is set in the CR bitmap which corresponds to a track that includes data modified as a result of satisfying the data modification operation. Operation 522 thereby includes updating the CR bitmap to reflect that data was modified as a result of performing the data modification operation at operation 518. As noted above, the CR bitmap is preferably used to keep track of data that is modified at the primary storage location while the primary and secondary storage locations are being synchronized. This allows for operations to still be performed as they are received, thereby maintaining throughput of the system and reducing computational resource consumption while also ensuring that the data at the two different storage locations remain accurate copies of each other and avoiding any data corruption issues.

Operation 524 further includes determining one or more extents that include the tracks that have been modified as a result of performing the data modification operation. In other words, operation 524 calculates the one or more extents which correspond to the modified tracks. This calculation may be performed differently depending on the type of memory, user preferences, system settings, industry standards, etc. For instance, in some approaches operation 524 may be performed by accessing a LPT and extrapolating which extent(s) the modified tracks are included in. Additional information such as metadata may also be used to perform operation 524. It also follows that any one or more of the approaches described above with respect to performing operation 510 may be implemented in order to perform operation 524.

Method 500 also includes using the information determined in operation 524 to set a bit in a second summary bitmap. See operation 526. Moreover, from operation 526, method 500 proceeds directly to operation 517. As noted above, each bit may correspond to a different track at the primary storage location, while multiple tracks may be combined together to form an extent. Thus, by identifying the one or more extents which include modified tracks therein, the second summary bitmap may be used to keep track of these extents.

In some approaches, each bit in the second summary bitmap may correspond to a different one of the extents that include the various tracks of data. The second summary bitmap may thereby have a much lower level of granularity than the CR bitmap. The second summary bitmap may be used to quickly and efficiently identify larger regions that include modified data, before using this information to perform a selective lookup in the CR bitmap to identify the specific tracks that include the modified data. This significantly reduces the amount of computing resources that are consumed in order to identify which data has been modified at the primary storage location but not yet synchronized with the secondary storage location.

While the second summary bitmap functions similarly to the first summary bitmap, they are preferably used to maintain data modifications that occur during different periods of time. For instance, while the first summary bitmap may be used to identify data modified outside the scope of any active synchronization procedures, the second summary bitmap may be used to identify data modified during any active synchronization procedures.

Referring now to FIG. 5B, exemplary sub-processes of actually synchronizing the data stored at the primary storage location with the data stored at the secondary storage location are illustrated in accordance with one embodiment. It follows that one or more of the illustrated sub-processes may be used to perform operation 516 of FIG. 5A. However, it should be noted that the sub-processes of FIG. 5B are illustrated in accordance with one embodiment which is in no way intended to limit the invention.

In response to determining that the data stored at the primary storage location should be synchronized with the data stored at the secondary storage location, the flowchart includes identifying bits set in the first summary bitmap. See sub-operation 540. As noted above, each bit that is set in the first summary bitmap corresponds to an extent that includes a modified track. The first summary bitmap may thereby be used to quickly and efficiently identify larger regions that include modified data, before using this information to perform a selective lookup in the first bitmap to identify the specific tracks that include the modified data. This effectively allows the system to identify the modified data without examining each entry in a more detailed bitmap (e.g., where each bit corresponds to a different track of data) and significantly reduces the amount of computing resources that are consumed in order to identify the modified data at the primary storage location.

Sub-operation 542 further includes using the set bits identified in sub-operation 540 and the first bitmap to determine the specific extents that include the modified tracks. In other words, sub-operation 542 calculates the one or more extents which correspond to the modified tracks. This calculation may be performed differently depending on the type of memory, user preferences, system settings, industry standards, etc. However, any one or more of the approaches that are described with respect to operation 510 of FIG. 5A may be implemented in order to perform sub-operation 542, e.g., as would be appreciated by one skilled in the art after reading the present description.

Once the modified tracks have been identified, a synchronization procedure may be initiated to ensure the corresponding data at the secondary storage location is updated to match. Accordingly, sub-operation 544 includes sending one or more instructions to synchronize the specific extents at the primary storage location that include the modified tracks with corresponding extents at the secondary storage location. According to some approaches, at least some of the instructions may be sent to the secondary storage location for implementation. In other approaches, the synchronization process may be performed using synchronization upper and lower tiers. For example, the upper tier may be used to actually identify the bits set in the summary bitmap, and when a set bit is found, the upper tier may allocate the corresponding extent object, e.g., as discussed above. The allocated extent object represents the synchronization work for one extent, and it may be transferred to the lower tier for processing after allocation.

While the synchronization process performed in sub-operation 544 was able to incorporate all of the data modifications tracked by the first bitmap and the first summary bitmap, data modification operations may be received during the synchronization process. As noted above, it is desirable that these operations are satisfied as they are received despite any ongoing synchronization process such that the system remains operational. Accordingly, it is desirable that the data modifications tracked by the CR bitmap and the second summary bitmap are replicated at the secondary storage location as well.

Accordingly, sub-operation 546 includes replacing the bits set in the first bitmap with the bits that are set in the CR bitmap. The bits set in the first bitmap are initially removed (e.g., deleted) from the first bitmap by resetting each of the respective bits. Once the first bitmap has effectively been reset, the bits that are set in the CR bitmap are transferred to the first bitmap. While the process of transferring the set bits may involve inspecting each bit in the CR bitmap in some approaches, in other approaches the second summary bitmap may actually be used to locate each of the bits that are set in the CR bitmap. As mentioned above, this significantly reduces compute processing and increases system throughput. The bits set in the CR bitmap are also reset (e.g., deleted) in response to being successfully transferred to the first bitmap. See sub-operation 548.

Sub-operation 550 further includes replacing the bits set in the first summary bitmap with the bits that are set in the second summary bitmap, while sub-operation 552 includes resetting the bits set in the second summary bitmap. As noted above, the bits set in the first summary bitmap are initially removed (e.g., deleted) from the first summary bitmap by resetting each of the respective bits. Once the first summary bitmap has effectively been reset, the bits that are set in the second summary bitmap are transferred to the first summary bitmap. The transfer of set bits between any two bitmaps as described herein may be achieved in some approaches by capturing a snapshot of the source bitmap and using the snapshot to update the bits in the target bitmap accordingly.

Proceeding to sub-operation 554, here the flowchart includes using the newly set bits in the first summary bitmap and the newly set bits in the first bitmap to identify extents at the primary storage location that include modified tracks. In other words, sub-operation 554 includes using the set bits transferred from the CR bitmap into the first bitmap and from the second summary bitmap into the first summary bitmap to calculate the specific extents that include modified tracks to be synchronized with the secondary storage location. This process of identifying (e.g., calculating) the extents may be satisfied using any of the approaches included herein (e.g., see sub-operation 542 of FIG. 5B and operations 524, 510 of FIG. 5A).

Furthermore, sub-operation 556 includes sending one or more instructions to synchronize the specific extents identified at the primary storage location as including the modified tracks with corresponding extents at the secondary storage location. It follows that sub-operation 556 may be performed using any of the approaches described above with respect to sub-operation 554, e.g., as would be appreciated by one skilled in the art after reading the present description.

Again, the process of utilizing summary bitmaps to more quickly and efficiently identify modified data to be synchronized with a secondary copy of data significantly improves performance of the system as a whole, particularly in comparison to the shortcomings experienced by conventional systems. Despite these substantial improvements to performance, failure events may unexpectedly occur during operation. For instance, the synchronization procedure may experience stall events, data read errors, network communication errors, etc., which may cause the synchronization to be stopped at least temporarily.

Referring now to FIG. 5C, exemplary processes of actually responding to a synchronization failure event are illustrated in accordance with one embodiment. It follows that one or more of the illustrated processes may be used to respond to an experienced failure event. However, it should be noted that the processes of FIG. 5C are illustrated in accordance with one embodiment which is in no way intended to limit the invention.

As shown, operation 570 includes actually detecting that a synchronization failure event has occurred. As mentioned above, the synchronization process may be stopped in response to a number of different situations that may negatively affect the process. Moreover, in response to actually detecting the synchronization failure event, operation 572 includes sending one or more instructions to stop synchronizing the specific extents at the primary storage location that include the modified tracks with corresponding extents at the secondary storage location. In other words, operation 572 includes actually stopping the synchronization process. This may desirably avoid data corruption issues as well as additional failure events.

While the synchronization process is stopped, bits that are set in the second summary bitmap and the CR bitmap may be transferred to the first summary bitmap and the first bitmap, respectively. This transfer of set bits may be performed without introducing any further risk of data corruption or synchronization failure as the synchronization process has been at least temporarily stopped. It follows that operation 574 includes integrating the bits set in the CR bitmap with the bits that are set in the first bitmap. In other words, operation 574 includes actually combining the bits that are already set in the first bitmap with the bits that are set in the CR bitmap. The combination of set bits is preferably maintained on the first bitmap, but may be stored in a different location, e.g., until the synchronization process is reinitiated.

Once the bits from the CR bitmap have been integrated with the set bits in the first bitmap, the CR bitmap may be reset without losing track of any data that has been modified at the primary storage location. Accordingly, operation 576 includes discarding the bits that are set in the CR bitmap.

Similar to operation 574, operation 578 includes integrating the bits set in the first summary bitmap with the bits that are set in the second summary bitmap. Moreover, operation 580 includes discarding the bits that are set in the second summary bitmap in response to them being successfully incorporated into the first summary bitmap, e.g., as described above.

It should be noted that the various bitmaps described herein may be formed, managed, and/or stored differently depending on the approach. For instance, in some approaches all bitmaps may be stored (e.g., maintained) in a same predetermined portion of memory, while in other approaches each bitmap may correspond to a different storage location. Moreover, each of the bitmaps may be formed a first time method 500 is performed and utilized on subsequent iterations of method 500, e.g., as would be appreciated by one skilled in the art after reading the present description.

According to an in-use example, which is in no way intended to limit the invention but which incorporates at least some of the approaches that are described above, each bit in an out of synchronization (OOS) summary bitmap represents whether any bits are set in a OOS bitmap for a corresponding extent in the volume of data. Moreover, when a data replication function managing the synchronization of data across primary and secondary storage locations is currently synchronizing the data, any data modification operations received will result in corresponding bits being set in a CR bitmap. Each bit in a CR summary bitmap further represents whether any bits are set in the CR bitmap for the corresponding extent in the volume.

Initially, all bits in the OOS summary bitmap and the CR summary bitmap are zeroed (not set), but when a synchronization relationship is established, e.g., such as when a peer-to-peer remote copy (PPRC) pair is established, a first pass of the OOS summary bitmap is performed as it has not yet been filled out. In situations where the storage locations have previously been synchronized (i.e., this is not an initial copy), not all tracks are being synchronized. Accordingly, an upper tier may examine the OOS bitmap to determine which extent objects to allocate. During this pass, if another write to a track is received, a bit in the OOS summary bitmap will be set. In this way, once this pass is completed, the OOS summary bitmap is then ready to be used by the upper tier in place of the OOS bitmap, thereby reducing computational overhead.

In situations where the storage locations are not currently being synchronized and a data modification operation is received, a bit is set in the OOS bitmap. Then the extent in the volume that corresponds to the modified track is calculated and the bit for the corresponding extent is set in the OOS summary bitmap. Alternatively, in situations where the storage locations are currently being synchronized and a data modification operation is received, a CR bitmap will be created (if not already created), and a bit is set in the CR bitmap. The extent in the volume that corresponds to the modified track may thereby be calculated, and the bit for the corresponding extent is set in the CR summary bitmap.

If the OOS summary bitmap is available to be used, as the upper tier performs a pass, it reads through the OOS summary bitmap looking for a next set bit. When a set bit is found, an extent object is allocated, which represents the synchronization work for one extent of the volume, and it is transferred to a lower tier to finish processing. At this point, the bit for the extent is reset in the OOS summary bitmap.

Moreover, when a track is successfully synchronized, the OOS bit is reset. Alternatively, if an error occurs while synchronizing the track, this will typically lead to a PPRC suspension and the synchronization process being stopped. The bit for the corresponding extent in the OOS summary bitmap may again need to be set at this point such that the synchronization can be attempted again.

When a consistency group is successfully formed, the tracks in the OOS bitmap have been synchronized and so the OOS bits are preferably reset. As a result, the contents of the CR bitmap may be used to replace the contents of the OOS bitmap, and the CR bitmap is subsequently discarded. In this case, the OOS summary bitmap bits are also reset, so the contents of the CR summary bitmap are also used to replace the contents of the OOS summary bitmap, after which the CR summary bitmap is zeroed.

However, when a consistency group fails to be formed, the contents of the CR bitmap are merged into the OOS bitmap, after which the CR bitmap can be discarded. In this case, the CR summary bitmap is merged into the 00S summary bitmap, and the CR summary bitmap may then be zeroed.

An alternative implementation would be for each bit in the summary bitmap to represent some other portion of the volume, rather than being tied to a respective extent. In other words, it should again be noted that while certain terms like “track” and “extent” are used herein, these are in no way intended to limit the invention. For example, a bit that is set in the first summary bitmap may actually refer to a portion of a volume having the extent which includes a modified track. The data and/or memory storing the data may also be divided into any desired number of portions of any desired size and may be referred to as desired. Moreover, each bit in the various bitmaps described herein may correspond to any desired amount of data, bits in other bitmaps, etc. Further still, it should be noted that the summary bitmaps can be stored as a volatile bitmap (e.g., in volatile memory) or as a non-volatile bitmap (e.g., in non-volatile memory) depending on the desired approach.

Use of the term “synchronize” herein is in no way intended to limit the invention either. Rather, any of the approaches included herein may be implemented in storage systems that implement any type of data duplication processes. For instance, any one or more of the approaches included herein may be implemented in a distributed storage system that applies an asynchronous data duplication scheme across primary and secondary storage locations, e.g., as would be appreciated by one skilled in the art after reading the present description.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Moreover, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving a data modification operation at a primary storage location;
determining whether data stored at the primary storage location is currently being synchronized with data stored at a secondary storage location; and
in response to determining that the data stored at the primary storage location is not currently being synchronized with the data stored at the secondary storage location:
sending one or more instructions to satisfy the data modification operation,
setting a bit in a first bitmap, wherein the bit in the first bitmap corresponds to a primary storage location track modified as a result of satisfying the data modification operation,
determining an extent that includes the modified track,
wherein the extent is formed of the modified track and at least one other primary storage location track, and
setting a bit in a first summary bitmap, wherein the bit in the first summary bitmap corresponds to the extent that includes the modified track.

2. The computer-implemented method of claim 1, wherein in response to determining that the data stored at the primary storage location is currently being synchronized with the data stored at the secondary storage location:
sending one or more instructions to satisfy the data modification operation;
setting a bit in a second bitmap, wherein the bit in the second bitmap corresponds to a track modified as a result of satisfying the data modification operation;
determining an extent that includes the modified track; and
setting a bit in a second summary bitmap, wherein the bit in the second summary bitmap corresponds to the extent that includes the track modified as a result of satisfying the data modification operation.

3. The computer-implemented method of claim 2, wherein synchronizing the data stored at the primary storage location with the data stored at the secondary storage location includes:
identifying bits set in the first summary bitmap, each set bit corresponding to a unique extent associated therewith that includes a modified track;
using the identified set bits and the first bitmap to determine the extents that include the modified tracks; and
sending one or more instructions to synchronize the extents at the primary storage location that include the modified tracks with corresponding extents at the secondary storage location.

4. The computer-implemented method of claim 3, wherein synchronizing the data stored at the primary storage location with the data stored at the secondary storage location includes:
replacing the bits set in the first bitmap with the bits that are set in the second bitmap;
replacing the bits set in the first summary bitmap with the bits that are set in the second summary bitmap;
using the newly set bits in the first summary bitmap and the newly set bits in the first bitmap to identify extents at the primary storage location that include modified tracks; and
sending one or more instructions to synchronize the identified extents at the primary storage location that include the modified tracks with corresponding extents at the secondary storage location.

5. The computer-implemented method of claim 2, comprising:
in response to experiencing a synchronization failure event, sending one or more instructions to stop synchronizing the extents at the primary storage location that include the modified tracks with corresponding extents at the secondary storage location;
integrating the bits set in the second bitmap with the bits that are set in the first bitmap;
discarding the bits that are set in the second bitmap;
integrating the bits set in the second summary bitmap with the bits that are set in the first summary bitmap; and
discarding the bits that are set in the second summary bitmap.

6. The computer-implemented method of claim 1, wherein the operations are performed by a controller coupled to the primary storage location, wherein the controller is configured to communicate with the secondary storage location, wherein the primary and secondary storage locations are geographically separated from each other, wherein data of the modified track is divided among a plurality of blocks of an extent at the primary storage location.

7. The computer-implemented method of claim 1, wherein the bit in the first summary bitmap refers to a portion of a volume having the extent that includes the modified track.

8. A computer program product comprising one or more computer readable storage media having program instructions embodied therewith, the program instructions readable and/or executable by a processor to cause the processor to:
receive, by the processor, a data modification operation at a primary storage location;
determine, by the processor, whether data stored at the primary storage location is currently being synchronized with data stored at a secondary storage location; and
in response to determining that the data stored at the primary storage location is not currently being synchronized with the data stored at the secondary storage location:
send, by the processor, one or more instructions to satisfy the data modification operation,
set, by the processor, a bit in a first bitmap, wherein the bit in the first bitmap corresponds to a primary storage location track modified as a result of satisfying the data modification operation,
determine, by the processor, an extent that includes the modified track,
wherein the extent is formed of the modified track and at least one other primary storage location track, and
set, by the processor, a bit in a first summary bitmap, wherein the bit in the first summary bitmap corresponds to the extent that includes the modified track.

9. The computer program product of claim 8, wherein in response to determining that the data stored at the primary storage location is currently being synchronized with the data stored at the secondary storage location:
sending one or more instructions to satisfy the data modification operation;
setting a bit in a second bitmap, wherein the bit in the second bitmap corresponds to a track modified as a result of satisfying the data modification operation;
determining an extent that includes the modified track; and
setting a bit in a second summary bitmap, wherein the bit in the second summary bitmap corresponds to the extent that includes the track modified as a result of satisfying the data modification operation.

10. The computer program product of claim 9, wherein synchronizing the data stored at the primary storage location with the data stored at the secondary storage location includes:
identifying bits set in the first summary bitmap, each set bit corresponding to a unique extent associated therewith that includes a modified track;
using the identified set bits and the first bitmap to determine the extents that include the modified tracks; and
sending one or more instructions to synchronize the extents at the primary storage location that include the modified tracks with corresponding extents at the secondary storage location.

11. The computer program product of claim 10, wherein synchronizing the data stored at the primary storage location with the data stored at the secondary storage location includes:
replacing the bits set in the first bitmap with the bits that are set in the second bitmap;
replacing the bits set in the first summary bitmap with the bits that are set in the second summary bitmap;
using the newly set bits in the first summary bitmap and the newly set bits in the first bitmap to identify extents at the primary storage location that include modified tracks; and
sending one or more instructions to synchronize the identified extents at the primary storage location that include the modified tracks with corresponding extents at the secondary storage location.

12. The computer program product of claim 9, wherein the program instructions are readable and/or executable by the processor to cause the processor to:
in response to experiencing a synchronization failure event, send, by the processor, one or more instructions to stop synchronizing the extents at the primary storage location that include the modified tracks with corresponding extents at the secondary storage location;
integrate, by the processor, the bits set in the second bitmap with the bits that are set in the first bitmap;
discard, by the processor, the bits that are set in the second bitmap;
integrate, by the processor, the bits set in the second summary bitmap with the bits that are set in the first summary bitmap; and
discard, by the processor, the bits that are set in the second summary bitmap.

13. The computer program product of claim 8, wherein the operations are performed by a controller coupled to the primary storage location, wherein the controller is configured to communicate with the secondary storage location, wherein the primary and secondary storage locations are geographically separated from each other, wherein data of the modified track is divided into blocks of an extent at the primary storage location.

14. The computer program product of claim 8, wherein the bit in the first summary bitmap refers to a portion of a volume having the extent that includes the modified track.

15. A system, comprising:
a processor; and
logic integrated with the processor, executable by the processor, or integrated with and executable by the processor, the logic being configured to:
receive, by the processor, a data modification operation at a primary storage location;
determine, by the processor, whether data stored at the primary storage location is currently being synchronized with data stored at a secondary storage location; and
in response to determining that the data stored at the primary storage location is not currently being synchronized with the data stored at the secondary storage location:
send, by the processor, one or more instructions to satisfy the data modification operation,
set, by the processor, a bit in a first bitmap, wherein the bit in the first bitmap corresponds to a primary storage location track modified as a result of satisfying the data modification operation,
determine, by the processor, an extent that includes the modified track,
wherein the extent is formed of the modified track and at least one other primary storage location track, and
set, by the processor, a bit in a first summary bitmap, wherein the bit in the first summary bitmap corresponds to the extent that includes the modified track.

16. The system of claim 15, wherein in response to determining that the data stored at the primary storage location is currently being synchronized with the data stored at the secondary storage location:
sending one or more instructions to satisfy the data modification operation;
setting a bit in a second bitmap, wherein the bit in the second bitmap corresponds to a track modified as a result of satisfying the data modification operation;
determining an extent that includes the modified track; and
setting a bit in a second summary bitmap, wherein the bit in the second summary bitmap corresponds to the extent that includes the track modified as a result of satisfying the data modification operation.

17. The system of claim 16, wherein synchronizing the data stored at the primary storage location with the data stored at the secondary storage location includes:
identifying bits set in the first summary bitmap, each set bit corresponding to a unique extent associated therewith that includes a modified track;
using the identified set bits and the first bitmap to determine the extents that include the modified tracks; and
sending one or more instructions to synchronize the extents at the primary storage location that include the modified tracks with corresponding extents at the secondary storage location.

18. The system of claim 17, wherein synchronizing the data stored at the primary storage location with the data stored at the secondary storage location includes:
replacing the bits set in the first bitmap with the bits that are set in the second bitmap;
replacing the bits set in the first summary bitmap with the bits that are set in the second summary bitmap;
using the newly set bits in the first summary bitmap and the newly set bits in the first bitmap to identify extents at the primary storage location that include modified tracks; and
sending one or more instructions to synchronize the identified extents at the primary storage location that include the modified tracks with corresponding extents at the secondary storage location.

19. The system of claim 16, wherein the logic is configured to:
in response to experiencing a synchronization failure event, send, by the processor, one or more instructions to stop synchronizing the extents at the primary storage location that include the modified tracks with corresponding extents at the secondary storage location;
integrate, by the processor, the bits set in the second bitmap with the bits that are set in the first bitmap;
discard, by the processor, the bits that are set in the second bitmap;
integrate, by the processor, the bits set in the second summary bitmap with the bits that are set in the first summary bitmap; and
discard, by the processor, the bits that are set in the second summary bitmap.

20. The system of claim 15, wherein the operations are performed by a controller coupled to the primary storage location, wherein the controller is configured to communicate with the secondary storage location, wherein the primary and secondary storage locations are geographically separated from each other, wherein the controller is configured to communicate with the secondary storage location using a wide area network.
